(19) United States
(12) Patent Application Publication
(10) Pub. No.: US 2007/0089571 A1
(43) Pub. Date: Apr. 26, 2007

(54) HAMMER HAVING A SIDE WORKING FACE

(76) Inventor: Yung-Shou Chen, Taichung County (TW)

Correspondence Address: PAI PATENT & TRADEMARK LAW FIRM, 1001 FOURTH AVENUE, SUITE 3200, SEATTLE, WA, 98154, US

(21) Appl. No.: 11/163,521

(22) Filed: Oct. 21, 2005

(51) Int. Cl. B25D 1/00; B25D 1/06

(52) U.S. Cl. 81/23; 81/24

(57) ABSTRACT

A hammer is disclosed, which has a nail groove axially formed in the top side of the front bell of the head thereof, a magnet mounted in the nail groove for attracting a metal nail for hammering, and a side face at each of the two opposite lateral sides of the head for hammering operations in a narrow space.

### BACKGROUND OF THE INVENTION

(a) Field of the Invention

The present invention relates to a hammer and more particularly, to such a hammer that has a side working face for hammering.

(b) Description of the Prior Art

A conventional hammer comprises a handle for grasping by the user, and a metal head fixedly fastened to one end of the handle. The metal head comprises a bell with a face at one end for driving a nail into a wall, and a claw at the other end for pulling a nail from the wall.

Because the metal head of a conventional hammer has a bell at one end and a claw at the other end, it must have a certain dimension to provide a sufficient weight so that the metal head can efficiently drive a nail into a wall with less effort. However, this design of hammer is not suitable for driving a nail into a wall in a narrow space. A hammer may be made having two flat cheeks at two opposite lateral sides of the metal head for driving a nail into a wall by moving the metal head of the hammer in transverse direction to strike one of the flat cheeks against the head of the nail. However, when working in a narrow space to drive a nail into a wall, it is difficult to keep the nail accurately in position.

### SUMMARY OF THE INVENTION

The present invention has been accomplished under the circumstances in view. It is one object of the present invention to provide a hammer, which is practical for use in a narrow space for hammering. According to one aspect of the present invention, the hammer comprises a handle and a head fastened to one end of the handle. The head has a bell at one end, a claw at the other end, and two side faces at two opposite lateral sides on the middle between the bell and the claw for hammering in a transverse direction in a narrow space. According to another aspect of the present invention, the bell of the head has a nail groove axially formed in the top side and a magnet fixedly mounted in the nail groove for attracting a metal nail for driving into a wall accurately.

### BRIEF DESCRIPTION OF THE DRAWINGS

FIG. 1 is a perspective view of a hammer according to the present invention.

FIG. 2 is a side view of the hammer according to the present invention.

FIG. 3 is a top view of the hammer according to the present invention.

FIG. 4 is a schematic drawing showing an application example of the hammer according to the present invention.

FIG. 5 is a schematic drawing showing side-hammering operation of the hammer according to the present invention.

FIG. 6 is a schematic side view of an alternate form of the hammer according to the present invention.

FIG. 7 is a schematic side view of yet another alternate form of the hammer according to the present invention.

### DETAILED DESCRIPTION OF THE PREFERRED EMBODIMENTS

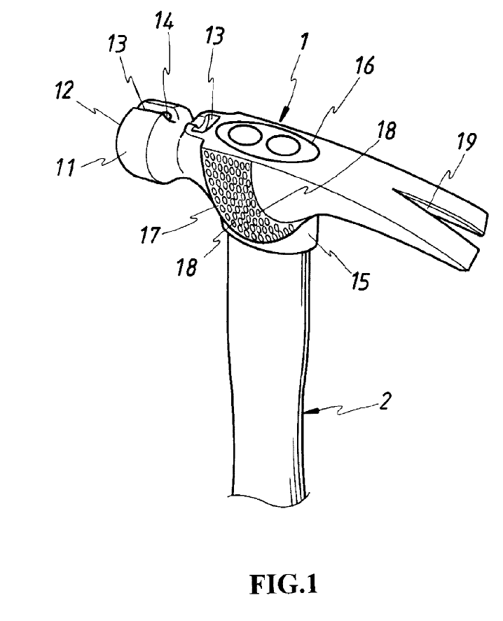

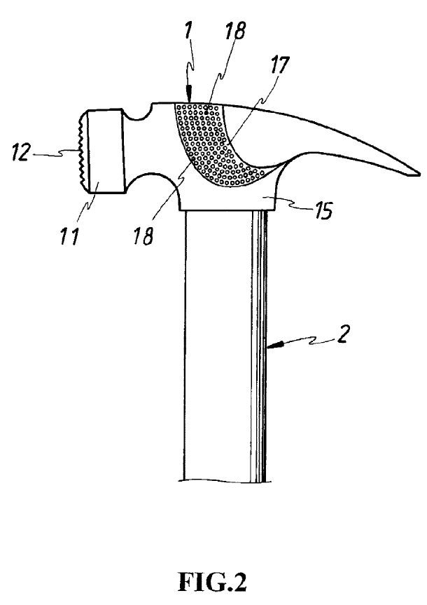

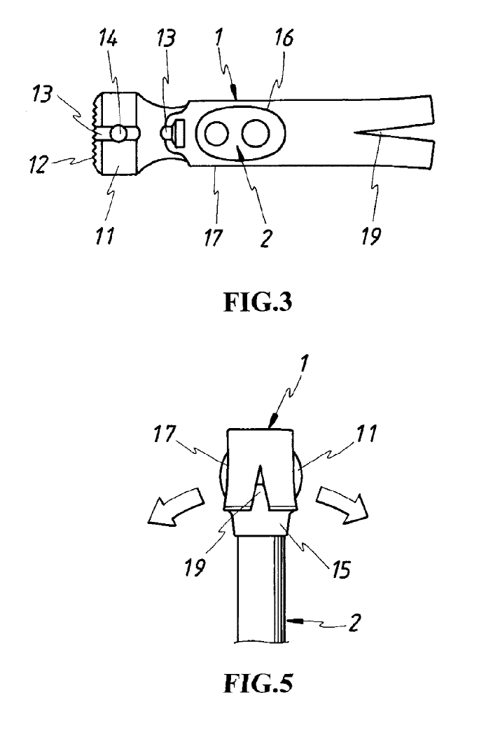

Referring to FIGS. 1˜3, a hammer in accordance with the present invention is shown comprising a handle 2 and a head 1 at one end of the handle 2. The head 1 has a bell 11 at one end, a nail groove 13 axially formed in the top side of the bell 11, a magnet 14 fixedly mounted in the nail groove 13, a claw 19 at the other end for extracting a nail, a coupling portion 15 on the middle between the bell 11 and the claw 19, a mounting through hole 16 cut through the top and bottom sides of the coupling portion 15 for receiving the handle 2, and at least one, for example, two side faces 17 at the opposite lateral sides of the coupling portion 16. The bell 11 has a coarse front face 12 for hammering. Each side face 17 has an anti-slip structure 18 to prevent slipping when hammering. The anti-slip structure 18 may be variously embodied. For example, the anti-slip structure 18 can be formed of raised and recessed portions, or intersected grooves. The handle 2 is fixedly fastened to the mounting through hole 16 of the coupling portion 15 of the head 1.

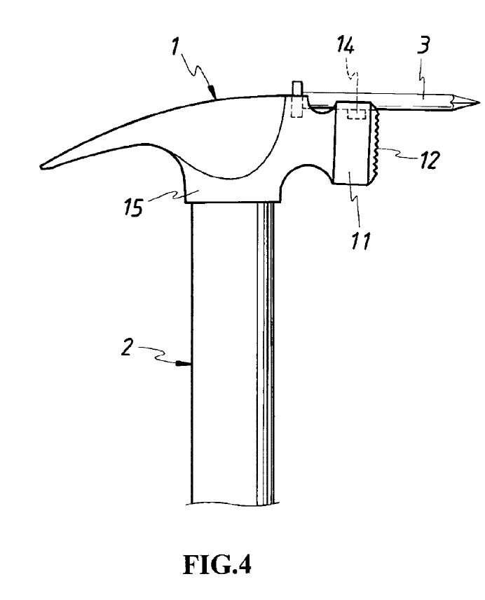

Referring to FIGS. 4 and 5, when using the coarse front face 12 of the bell 11 for driving a metal nail 3 into a wall, the metal nail 3 can be positioned in the nail groove 13 and secured thereto by the magnet 14 for pre-mounting into the wall without holding the metal nail 3 with the hand (see FIG. 4). When working in a narrow space, the hammer can be inserted into the narrow space and then moved in transverse direction to strike one side face 17 against the workpiece (for example, a metal nail).

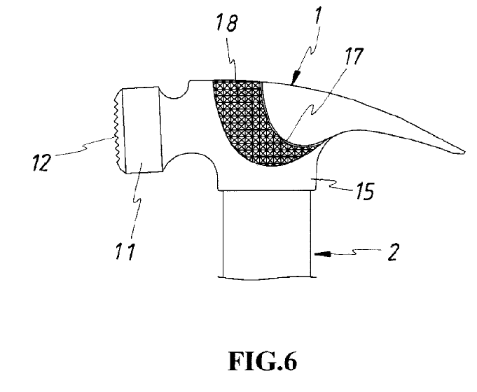

FIG. 6 shows an anti-slip structure 18 of the side face 17 of head 1 of hammer according to the present invention.

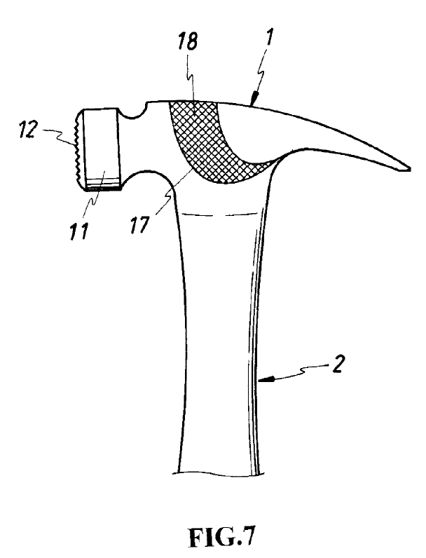

FIG. 7 shows an alternate form of the hammer according to the present invention. According to this embodiment, the head 1 is formed integral with one end of the handle 2. This embodiment eliminates the aforesaid coupling portion 15 and mounting through hole 16. Same as the aforesaid first embodiment, the head 1 of this second embodiment has a side face 17 at each side, and an anti-slip structure 18 at each side face 17.

A prototype of hammer has been constructed with the features of FIGS. 1˜7. The hammer functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A hammer comprising a head, said head comprising a bell at a front end thereof, and a handle perpendicularly connected to a middle part of said head, wherein said head has a side face at at least one of two opposite lateral sides thereof for hammering, said side face having an anti-slip structure.

2. The hammer as claimed in claim 1, wherein said anti-slip structure is comprised of a plurality of recessed portions.

3. The hammer as claimed in claim 1, wherein said anti-slip structure is comprised of a plurality of raised portions.

4. The hammer as claimed in claim 1, wherein said anti-slip structure is comprised of a plurality of intersected grooves.

5. The hammer as claimed in claim 1, wherein said bell has a coarse front face.

6. The hammer as claimed in claim 1, wherein said head has a nail groove axially formed in a top side thereof for receiving a metal nail, and a magnet fixedly mounted in said nail groove for attracting the metal nail received in said nail groove.

7. The hammer as claimed in claim 1, wherein said head has a coupling portion on a middle part thereof, and a mounting through hole cut through top and bottom sides of said coupling portion for receiving one end of said handle.

8. The hammer as claimed in claim 1, wherein said head has a claw at a rear end thereof.
